(19) United States
(12) Patent Application Publication
(10) Pub. No.: US 2015/0120478 A1
(43) Pub. Date: Apr. 30, 2015

(54) APPARATUS AND METHOD FOR ELECTRONIC RECEIPT

(71) Applicant: Samsung SDS CO., LTD., Seoul (KR)

(72) Inventors: Sung Ho JANG, Seoul (KR); In Cheon LEE, Seoul (KR)

(73) Assignee: Samsung SDS CO., LTD., Seoul (KR)

(21) Appl. No.: 14/142,012

(22) Filed: Dec. 27, 2013

(30) Foreign Application Priority Data
Oct. 30, 2013 (KR) 10-2013-0129658

(51) Int. Cl. G06Q 20/20

(52) U.S. Cl. CPC G06Q 20/209
USPC 705/24

(57) ABSTRACT

There are provided an electronic receipt management device and a method thereof. The electronic receipt management system according to an embodiment of the present disclosure includes a data collecting device configured to detect a control event transmitted from a payment device to a printer output unit, collect data transmitted from the payment device to the printer output unit, and convert the collected data into a predefined format, and an electronic receipt management device configured to receive the data converted into a standardized format from the data collecting device, compare the received data and a user database for matching a receipt user, and issue an electronic receipt to the matching user.

### CROSS-REFERENCE TO RELATED APPLICATION

This application claims priority to and the benefit of Republic of Korea Patent Application No. 10-2013-0129658 filed on Oct. 30, 2013, the disclosure of which is incorporated herein by reference in its entirety.

### BACKGROUND

1. Technical Field

The present disclosure relates to technology for managing and issuing an electronic receipt to a purchaser after purchasing a product.

2. Discussion of Related Art

Recently, a result of collecting and analyzing transaction information or payment information generated when a consumer purchases a product has been increasingly used for a loyalty program, advertisement, sales promotion, or marketing. Although there are various solutions for collecting such transaction information or payment information, the solutions collect only simple information such as a consumer visiting history or card authorization information.

In order to perform an effective consumer analysis service and target marketing, in addition to general consumer information such as age, gender, residence, and occupation, various and detailed transaction data from which a purchase pattern such as a frequently purchased item or a purchasing place of the consumer can be extracted is required. Such information may be extracted from purchase history data of a receipt issued from an existing POS system. However, it is difficult for a user to efficiently manage a paper receipt issued from the POS system whenever the user pays the price. Further, it is more difficult to integrate and use the receipt for analysis. Although a few credit card companies provide purchase history pattern information of a card user using store information, they do not provide a detailed purchase history of the user.

In order to address inconvenience of the paper receipt and a limitation of credit card usage history information, an electronic receipt for collecting and managing a consumer purchase history has entered the spotlight. Without issuing a paper receipt serving as a purchase evidence document of the consumer, the electronic receipt smartly transmits and stores a transaction history of the consumer in an electronic receipt form. However, current electronic receipt systems have problems in that an additional NFC device or tag for issuing an electronic receipt in addition to existing POS equipment or modification of a POS application is necessary. In addition, it is difficult to keep and secure the receipt. These problems are becoming an obstacle of electronic receipt activation.

Solutions related to the electronic receipt are classified as a receipt scanning method or an NFC method. In the receipt scanning method, the consumer generates a picture image of a paper receipt issued through the POS system using a camera installed in a smartphone of the consumer, extracts important information using optical character recognition (OCR) software, inputs the information to a section matching a receipt item, and generates an electronic receipt. In the store side, it is possible to generate the electronic receipt without an additional device or POS application modification. However, since a recognition rate of the OCR is lower than an expected rate, receipt information is frequently extracted as a text type different from actual information. In addition, when the receipt is captured by the camera, the recognition rate is significantly influenced by a capturing quality due to a capturing angle and a light intensity. Data extracted through this method is difficult to be made in a standard text format and is difficult to be stored in a database. Further, whenever the consumer pays the price, capturing is required to issue a receipt.

In the near field communication (NFC) method, a user of a smartphone having an NFC read and write function downloads an electronic receipt application, contacts the smartphone to an issuing terminal (NFC transceiver), and receives the electronic receipt in the smartphone of the user through near field wireless communication. A simple action of contacting the terminal is used to issue the electronic receipt and thus it provides a high level of user convenience. However, an additional device capable of performing the NFC read and write function, that is not provided in a legacy POS, is necessary to perform near field wireless communication. This is the biggest factor to undermine the spread of the electronic receipt. Currently, smartphones having an NFC function are less than 20% of worldwide smartphones and only few smartphone users can use such an electronic receipt solution. In addition, it is difficult to keep the receipt in the smartphone or a SIM chip. In this case, a storage space may be insufficient or important payment and transaction information may be deleted when the smartphone needs to be initialized due to inevitable conditions. Private information such as credit card information is recorded in electronic receipt information. Therefore, when the phone is lost or hacked, problems may occur due to private information leakage.

Since these existing methods require the user's action change or the additional device in addition to an existing infrastructure, it is difficult to build an appropriate service environment, and collect and manage receipt information in standardized data. In addition, since corresponding information is stored and managed in a memory of the user terminal, storage and security problems may occur.

### SUMMARY

In view of the above-described problems, according to embodiments of the present disclosure, in order to issue an electronic receipt without an additional device or modifying an existing application in an environment having a plurality of POS systems, print data generated from the POS system is collected using an agent, various types of collected data is standardized through a preprocess including parsing, attribute matching of the standardized information and user information is performed, and the electronic receipt is issued to a terminal of a user having a matching attribute value.

In addition, an electronic receipt file is stored and maintained in a cloud storage assigned to the user instead of the user terminal, and thus it is possible to easily manage and analyze consumption data.

According to an aspect of the present disclosure, there is provided an electronic receipt data collecting device. The device includes a data collecting module configured to collect data transmitted from a payment device to a printer output unit when a control event transmitted from the payment device to the printer output unit is detected, and a data relay module configured to convert the collected data into a predefined format.

The device may further include a data transmitting module configured to transmit the converted data to an electronic receipt management device.

When a control event generated from the payment device is detected, the data collecting module may collect data delivered as a parameter of the control event, transmit the collected data to the data relay module, and transmit the data to the printer output unit when or after the data is transmitted.

The data relay module may include a data parsing unit configured to divide the collected data according to a predetermined format, and a data refining unit configured to remove an unnecessary symbol or text from the divided data or insert a preset value when there is no value corresponding to the predetermined format in the divided data.

The data relay module may further include a data converting unit configured to convert data refined in the data refining unit into an integrated database format for electronic receipt management.

The payment device may be included in computer hardware having the electronic receipt data collecting device included therein or connected to the electronic receipt data collecting device through a network connection unit.

According to another aspect of the present disclosure, there is provided an electronic receipt management device. The device includes a data receiving unit configured to receive receipt data from a receipt data collecting device and input the data in an integrated receipt database, and a data mapping unit configured to receive the receipt data from the data receiving unit and compare transaction information in a user database and attribute information of the receipt data for matching a receipt user.

The device may further include a receipt issuing unit configured to, when the receipt user matches, generate an electronic receipt using the receipt data, and transmit the electronic receipt to the receipt user selectively using either an ID or phone number of the matching receipt user, and a storage device configured to store the generated receipt.

The data mapping unit may match transaction information in the user database and receipt attribute information using at least one of a credit card number, a phone number, and a receipt ID of the receipt user.

A type of the electronic receipt may include any of a text, an image, or a document file, and the receipt user may receive the electronic receipt through any of an SMS, an email, or a mobile terminal of the user.

The storage device may be included in computer hardware having the electronic receipt management device included therein or connected to the electronic receipt management device through an external network connection unit.

According to still another aspect of the present disclosure, there is provided an electronic receipt data collecting method. The method includes collecting data transmitted from a payment device to a printer output unit when a control event transmitted from the payment device to the printer output unit is detected, converting the collected data into a predefined format, and transmitting the converted data.

The collecting of the data may further include dividing the collected data according to a predetermined format, refining of data that includes removing an unnecessary symbol or text from the divided data or inserting a preset value when there is no value corresponding to the predetermined format in the divided data, and converting the refined data into an integrated database format.

According to yet another aspect of the present disclosure, there is provided an electronic receipt management method. The method includes receiving receipt data from a receipt data collecting device and inputting the data in an integrated receipt database, and receiving the receipt data and comparing transaction information in a user database and attribute information of the receipt data for matching a receipt user.

The method may further include generating an electronic receipt using the receipt data when the receipt user matches, and transmitting the electronic receipt to the receipt user using an ID or phone number of the matching receipt user.

In the matching of the receipt user, at least one of a credit card number, a phone number, and a receipt ID of the user may be used to match the receipt user.

In the generating of the electronic receipt, a type of the electronic receipt may include any of a text, an image, or a document file, and the receipt user may receive the electronic receipt through either the user's email or an SMS.

According to yet another aspect of the present disclosure, there is provided an electronic receipt management system. The system includes a data collecting device configured to detect a control event transmitted from a payment device to a printer output unit, collect data transmitted from the payment device to the printer output unit, and convert the collected data into a predefined format, and an electronic receipt management device configured to receive the converted data from the data collecting device, compare the received data and a user database for matching a receipt user, and issue an electronic receipt to the matching user.

The data collecting device may divide the collected data according to a predetermined format, remove an unnecessary symbol or text from the divided data, or insert a preset value when there is no value corresponding to the predetermined format.

The electronic receipt management device may selectively use any of a credit card number, a phone number, and a receipt ID of the receipt user to match the receipt user, and selectively use any of an SMS, an email, or a mobile terminal of the receipt user to transmit the electronic receipt.

The system may further include a user terminal configured to send identification information of the receipt user to the electronic receipt management device and receive the electronic receipt.

The user terminal may provide a dedicated interface for issuing and managing the electronic receipt to the receipt user and provide the identification information to the electronic receipt management device through the interface.

The identification information may selectively use any of a credit card number, a phone number, and a receipt ID of the receipt user.

### BRIEF DESCRIPTION OF DRAWINGS

FIG. 1 is a block diagram illustrating a detailed configuration of an electronic receipt management system according to an embodiment of the present disclosure.

FIG. 2 is a diagram illustrating a configuration of a S/W structure of a POS system 10 for issuing a receipt and a data collecting device 20 according to an embodiment of the present disclosure.

FIG. 3 is a diagram illustrating another configuration of a S/W structure of a POS system 10 for issuing a receipt and a data collecting device 20 according to an embodiment of the present disclosure.

FIG. 4 is a diagram illustrating a detailed configuration of the data collecting device 20 according to the embodiment of the present disclosure.

FIG. 5 is a diagram illustrating a detailed configuration of a data relay module 220 according to an embodiment of the present disclosure.

FIG. 6 is a diagram illustrating a detailed configuration of an electronic receipt management device 30 according to an embodiment of the present disclosure.

FIG. 7 is a flowchart illustrating an electronic receipt issuing method that is performed in an electronic receipt management system according to an embodiment of the present disclosure.

### DESCRIPTION OF EXAMPLE EMBODIMENTS

Hereinafter, exemplary embodiments of the present disclosure will be described in detail with reference to the drawings. However, these are only examples and the present disclosure is not limited thereto.

In descriptions of the present disclosure, when it is determined that detailed descriptions of related well-known functions unnecessarily may obscure the gist of the present disclosure, detailed descriptions thereof will be omitted. Some terms described in below are defined by considering functions in the present disclosure and meanings may vary depending on, for example, a user or operator's intentions or customs. Therefore, the meanings of terms should be interpreted based on the contents throughout this specification.

The spirit and scope of the present disclosure is defined by the appended claims. The following embodiments are only made to efficiently describe the technological scope of the present disclosure to those skilled in the art.

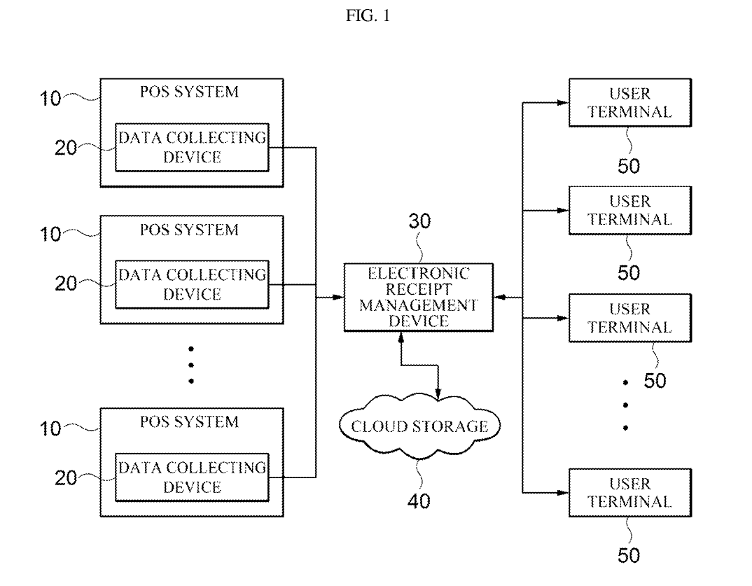

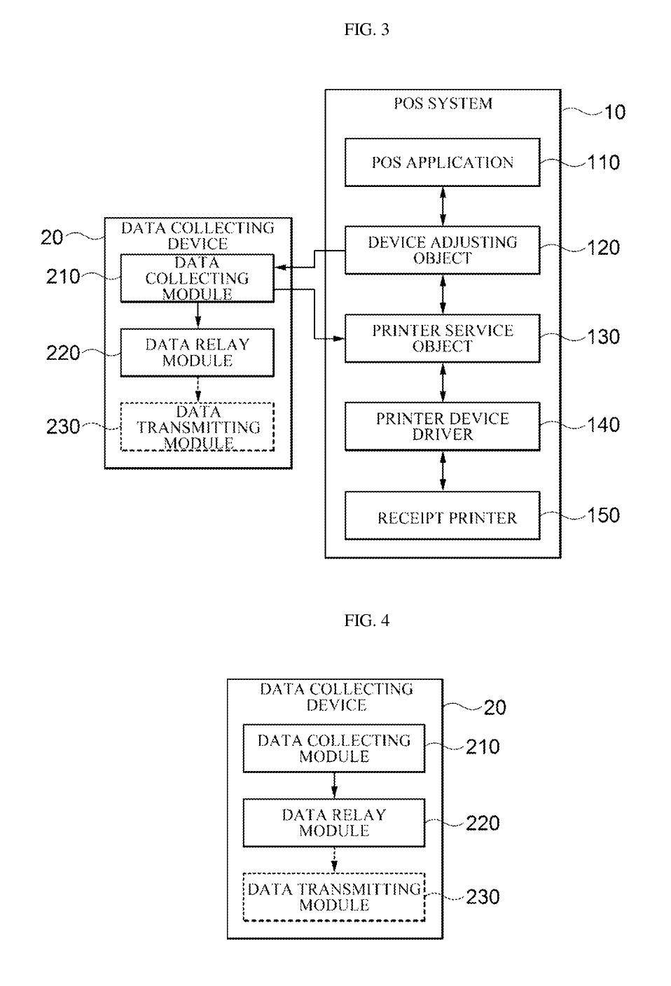

FIG. 1 is a block diagram illustrating a detailed configuration of an electronic receipt management system for addressing the above-described problems according to an embodiment of the present disclosure. As illustrated, the electronic receipt management system according to the embodiment of the present disclosure includes a POS system 10, a data collecting device 20, an electronic receipt management device 30, a cloud storage 40, and a user terminal 50. In the embodiment illustrated in FIG. 1, the data collecting device 20 is included in the POS system. However, this is only an example. Depending on a receipt data collecting environment, the data collecting device 20 according to embodiments of the present disclosure may be included in the POS system 10, or may be provided outside the POS system 10 and be connected through a separate network unit as illustrated in the embodiment of FIG. 3. It should be noted that various modified configurations of the data collecting device 20 may be possible and the modifications are included in the scope of the present disclosure.

Hereinafter, detailed configurations of the POS system 10, the data collecting device 20, the electronic receipt management device 30, the cloud storage 40, and the user terminal 50 will be described.

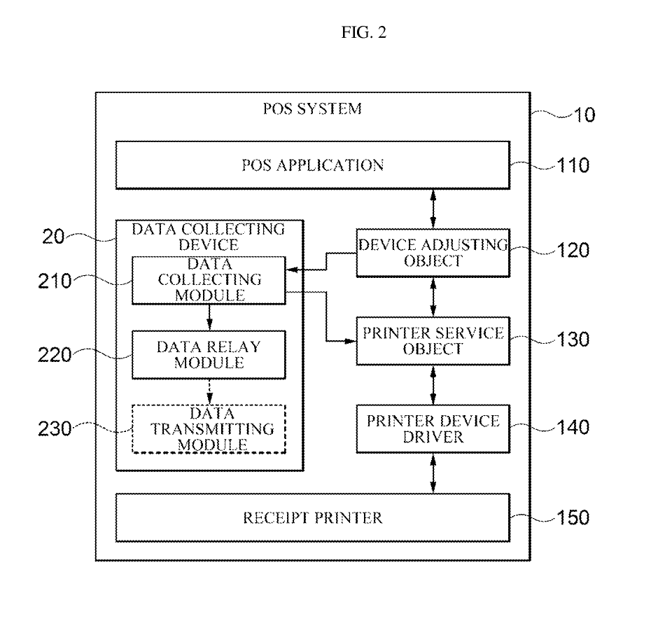

FIGS. 2 and 3 are diagrams illustrating detailed configurations of the data collecting device 20 and the POS system 10 for issuing a receipt according to an embodiment of the present disclosure. The POS system 10 connects a host computer and a POS terminal installed in a store, simultaneously inputs transaction information when a product is sold, and then uses the transaction information to pay for the product, manage sales and inventory, or the like. The POS system includes a POS application that is directly or indirectly shown to a consumer at point of sale, a barcode scanner used to interact with the consumer or a casher, a peripheral device such as a receipt printer and a sign pad, and an operating system that manages the POS application and provides a device driver for controlling the peripheral device.

When the consumer purchases a product, a POS application 110 processes payment of a corresponding product and issues a corresponding purchase history through the receipt printer. Generally, this POS application is developed to satisfy specific print requirements of shops, malls, and retailers that use the POS system 10, and there are many kinds of POS application. Therefore, it is almost impossible to modify the POS application or add a function to issue an electronic receipt. In the present disclosure, an application layer of the POS system is not modified, text information, that is output to a printer through a standard interface between an application layer and a device control layer such as an OPOS and a JPOS, is hooked, and the electronic receipt is generated based on the hooked text information. In order to output a receipt in response to a request of the POS application 110, as illustrated in FIG. 2, a device adjusting object 120 for printer control is generated, a printer service object 130 for processing a printer-related function is generated, and then a print related method provided from the objects is called. Therefore, a receipt printer 150 is controlled through a printer device driver 140.

FIG. 4 illustrates the data collecting device 20 according to an embodiment of the present disclosure. The data collecting device 20 includes a data collecting module 210, a data relay module 220, and a data transmitting module 230. The data collecting module 210 monitors printer control methods called by the device adjusting object when a receipt is output, collects receipt data delivered as a parameter when the print related method is called, and transmits the data to the data relay module 220. The data relay module 220 preprocesses various forms of print data received from the data collecting module 210 and converts the data into an integrated data set form that can be used in the electronic receipt. The data transmitting module 230 transmits the converted data to the electronic receipt management device 30. However, the data transmitting module 230 is not an essential component, and the data relay module 220 may perform a function on behalf of the data transmitting module 230 depending on a receipt data collecting environment.

The data collecting device 20 according to the embodiment of the present disclosure will be described in detail. The data collecting module 210 monitors printer control methods called by the device adjusting object 120 in a receipt output process, collects receipt data delivered as a parameter when the print related method is called, transmits the collected data to the data relay module 220, transmits the receipt data to the printer service object 130 at the same time or later, and allows an actual receipt to be output in the receipt printer 150 through the device driver 140. More specifically, the data collecting module 210 detects a control event of the receipt printer processed through the standard interface and collects text data transmitted from the POS application 110 to the receipt printer 150. To this end, the data collecting module 210 communicates with the device adjusting object 120 and the printer service object 130, and provides a callback function for data hooking. That is, when the POS application 110 calls a related method of the device adjusting object 120 in order to output a receipt, the data collecting module 210 detects the call, collects print data by passing a parameter of the callback function, and passes the method to the printer service object 130. For example, when it is assumed that the operating system of the POS system is Windows of Microsoft and supports OPOS control for controlling the peripheral device, the data collecting module 210 takes Data serving as a parameter of a corresponding command and makes a message of string-type data stored in a memory address designated by *Data when a command of PrintNormal (LPCTSTR Data) among OLE POS commands is called. Then, the data collecting module 210 delivers collected text-type message data to the data relay module 220, includes a security and encryption function for transmitting sensitive data such as a credit card number, and transmits the data in real time or at once according to a predefined time interval depending on a workload of the POS system 10 or the data relay module 220 and a network condition.

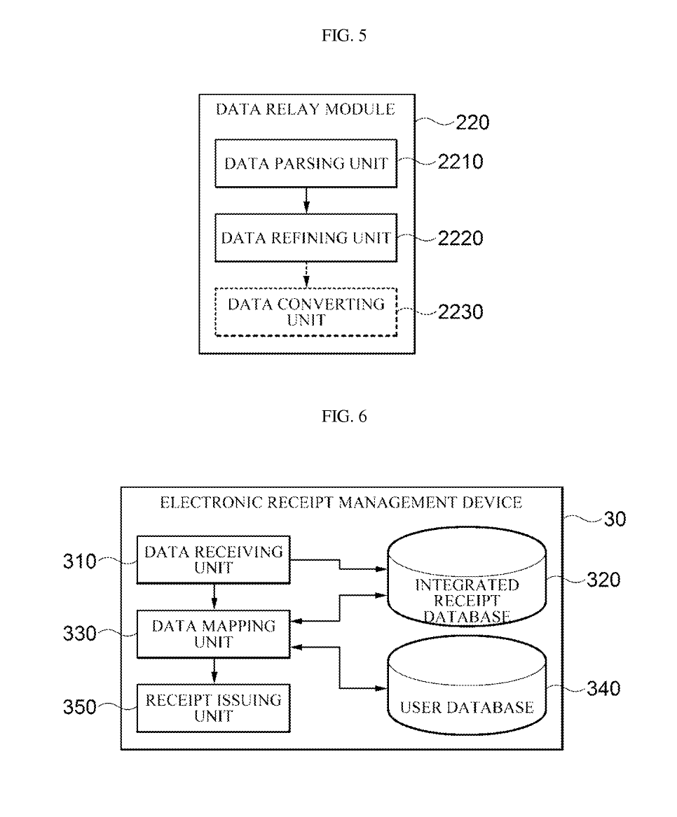

FIG. 5 illustrates the data relay module 220 according to an embodiment of the present disclosure. The data relay module 220 preprocesses various types of receipt print data received from the data collecting module 210 and converts the data into an integrated data set form that can be used in the electronic receipt. To this end, the data relay module 220 includes a data parsing unit 2210 configured to extract data matching a receipt item from the received message data, a data refining unit 2220 configured to fill a missing value of the receipt print data having imperfection and inconsistency due to a different data output type, and identify and remove an unnecessary value, and a data converting unit 2230 configured to convert refined data into an appropriate form matching the integrated receipt database.

The data relay module 220 according to the embodiment of the present disclosure will be described in detail. The data parsing unit 2210 finds out a pattern of a predefined receipt item (attribute) from received text-type receipt print data and stores the pattern in a database. For example, when there is a 16-digit number including “**,” it is determined as a card number, and when there is a digit string including “,” before a 3-digit number, it is determined as a price. The data refining unit 2220 removes an unnecessary symbol or text from data parsed by the data parsing unit 2210, substitutes a missing value by automatically filling a value according to a separately defined standard when there is no value corresponding to the receipt item, and matches each receipt item value and a standard format. For example, when a transaction date of “20130818” is input, it is converted into “08/18/2013,” when a card number of “12345678******90” is input, it is converted into“1234-5678-****-**90,” and when there is no receipt ID value, it may be replaced with “unknown.” The data converting unit 2230 converts data input from the data refining unit 2220 into an integrated database format for managing an electronic receipt, makes a message thereof, transmits the message to the electronic receipt management device 30, and provides a security and encryption function therefor. However, the data converting unit 2230 is not an essential component, and the data refining unit 2220 may perform a function on behalf of the data converting unit 2230 depending on a receipt data collecting environment.

FIG. 6 illustrates the electronic receipt management device 30 according to an embodiment of the present disclosure. The electronic receipt management device 30 stores receipt information input from a plurality of data collecting devices 20 in a database, maps user information subscribed in an electronic receipt and corresponding receipt information, issues an electronic receipt to a matching user, and stores corresponding receipt data in the cloud storage 40. To this end, the electronic receipt management device 30 includes a data receiving unit 310, an integrated receipt database 320, a data mapping unit 330, a user database 340, and a receipt issuing unit 350. However, in the embodiments of the present disclosure, each component of the electronic receipt management device 30 is only an example according to a function. Therefore, various modifications may be made, for example, each component may be integrated into one function depending on a receipt collection and management environment, and it should be noted that all modifications may be included in the scope and sprit of the present disclosure.

The electronic receipt management device 30 according to the embodiment of the present disclosure will be described in detail. The data receiving unit 310 receives receipt data from the data collecting devices 20, inputs the data in the integrated receipt database 320 as a new record, and delivers the data to the data mapping unit 330. The data mapping unit 330 determines which user receipt data is input from the data receiving unit 310 through attribute matching and then maps a matching user and the receipt data. For data mapping, the data mapping unit 330 communicates with the integrated receipt database 320 in which transaction information such as a store address, a transaction date, a credit card number, and transaction amount of money is stored and the user database 340 in which private information such as a user's phone number, a credit card number, and an email address is stored and managed. Matching of two databases is performed using a specific data attribute as a key. When the attribute value matches, the user is determined as a receipt recipient and thus the receipt database data is connected to corresponding user data. The data attribute includes a credit card number, a phone number, a receipt ID of the user, or the like. The data mapping unit 330 delivers the user data and the receipt data that are mapped to issue an electronic receipt to the receipt issuing unit 350.

The receipt issuing unit 350 according to the embodiment of the present disclosure uses a user terminal ID or a phone number of the mapped user registration information, utilizes an SMS or message communication of a user application installed in the user terminal 50, and issues an electronic receipt. A type of the electronic receipt may be selected by the user from among a text, an image, or a document file and issued. In addition, the issued electronic receipt data is stored in the cloud storage 40 that is assigned when the user subscribes to an electronic receipt service. The user may load electronic receipt data stored in the cloud storage 40 through the user terminal 50.

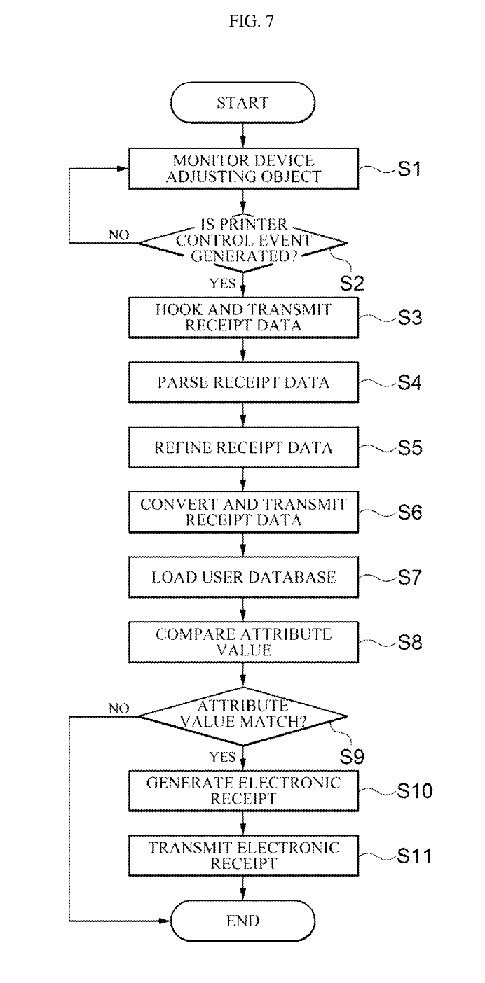

FIG. 7 is a flowchart illustrating an electronic receipt issuing method that is performed in an electronic receipt management system according to an embodiment of the present disclosure.

The data collecting module 210 of the data collecting device 20, that is installed inside the POS system 10, or installed outside the POS system 10 and connected through a network unit, monitors whether a print control method provided from the POS application 110 to the device adjusting object 120 is called (S1). When a consumer purchases a specific product or service and then requests to issue a receipt, a shopkeeper clicks a receipt button on a screen of the POS system 10, and the POS application 110 generates a receipt print event and calls a related print control method (S2). When the printer control event (S2) is generated, the data collecting module 210 of the data collecting device 20 hooks the method, extracts receipt data for outputting, and transmits the data to the data relay module 220 (S3).

The data parsing unit 2210 in the data relay module 220 uses a pattern of a predefined receipt item (attribute) to parse the received receipt data (S4), removes an unnecessary symbol or text from the parsed receipt data, and when there is a missing value, it is replaced with a predefined input value in the data refining unit 2220 and corresponding data is refined (S5). Then, in the data converting unit 2230, the refined receipt data is converted into an integrated receipt database format and then is transmitted to the electronic receipt management device 30 (S6).

The electronic receipt management device 30 inputs the received receipt data to the integrated receipt database as a new record and loads a user database for data mapping (S7). In addition, the electronic receipt management device 30 compares an attribute value of the receipt data and an attribute value of user data using a specific data attribute such as a credit card number as a key (S8). When two attribute values match (S9), the receipt data is used to generate an electronic receipt (S10) and a matching user terminal ID or phone number is used to transmit the generated electronic receipt (S11).

Meanwhile, exemplary embodiments of the present disclosure may include a computer-readable recording medium including a program for performing the methods, described herein, using a general purpose or specialized computer. The computer-readable recording medium may separately include program commands, local data files, local data structures, etc. or include a combination of them. The medium may be specially designed and configured for the present disclosure, or known and available to those of ordinary skill in the field of computer software. Examples of the computer-readable recording medium, in a non-transitory aspect, include magnetic media, such as a hard disk, a floppy disk, and a magnetic tape, optical recording media, such as a CD-ROM and a DVD, magneto-optical media, such as a floptical disk, and hardware devices, such as a ROM, a RAM, and a flash memory, specially configured to store and perform program commands. Examples of the program commands may include high-level language codes executable by a computer using an interpreter, etc. as well as machine language codes made by compilers. Inasmuch as a computer is a device that is well known to those familiar with this field, a detailed description, of the hardware processor of such a computer, or of the manner in which the computer-readable recording medium may be employed to implement the various devices or units, and to control the variously described operations using the processor, is not provided. Likewise, a description of well known output devices such as displays, printers, data files on magnetic or optical media, and the like, for outputting results, is also not provided.

According to embodiments of the present disclosure, without an additional hardware device or modifying an existing POS application in an environment having a plurality of existing POS systems, it is possible to collect various types of receipt data generated from POS applications in a stereotyped or standardized format. In addition, according to embodiments of the present disclosure, transaction data or a receipt image file is not directly stored in the user terminal, but a cloud storage is assigned for each user and transaction data or receipt information is stored in a corresponding storage. Therefore, it is possible to minimize a data loss due to an insufficient storage and a private information leakage due to the loss or hacking of the terminal.

While the present disclosure has been described in detail with reference to exemplary embodiments, it will be understood by those skilled in the art that various modifications may be made without departing from the spirit and scope of the present disclosure.

Therefore, the scope of the present disclosure is defined not by the described embodiments but by the appended claims to be described and encompasses equivalents that fall within the scope of the appended claims.

What is claimed is:

1. An electronic receipt data collecting device, comprising:
a data collecting module configured to collect data transmitted from a payment device to a printer when a control event transmitted from the payment device to the printer is detected;
a data relay module configured to convert the collected data into a predefined format; and
a hardware processor configured to implement at least one from among the data collecting module and the data relay module.

2. The device of claim 1, further comprising a data transmitting module configured to transmit the converted collected data to an electronic receipt management device.

3. The device of claim 1, wherein, when the control event transmitted from the payment device is detected, the data collecting module collects data delivered as a parameter of the control event, transmits the collected data to the data relay module, and transmits the data to the printer when or after the data is transmitted.

4. The device of claim 1, wherein the data relay module comprises:
a data parser configured to divide the collected data according to a predetermined format; and
a data refiner configured to remove an unnecessary symbol or text from the divided collected data to output refined data or insert a preset value when there is no value corresponding to the predetermined format in the divided collected data, to output the refined data.

5. The device of claim 4, wherein the data relay module further comprises a data converter configured to convert the refined data refined into an integrated database format for electronic receipt management.

6. The device of claim 1, wherein the payment device is included in a computer hardware having the electronic receipt data collecting device included therein or the payment device is connected to the electronic receipt data collecting device through a network connection unit.

7. An electronic receipt management device, comprising:
a data receiver configured to receive receipt data from a receipt data collecting device and input the receipt data in an integrated receipt database;
a data mapper configured to receive the receipt data from the data receiver and compare transaction information in a user database and attribute information of the receipt data for matching a receipt user; and
a hardware processor configured to implement at least one of the data receiver and the data mapper.

8. The device of claim 7, further comprising:
a receipt issuer configured to, when the receipt user matches, generate an electronic receipt using the receipt data, and selectively transmit the electronic receipt to the receipt user using an ID or phone number of the matching receipt user; and
a storage device configured to store the generated electronic receipt.

9. The device of claim 7, wherein the data mapper matches transaction information in the user database and receipt attribute information using at least one from among a credit card number, a phone number, and a receipt ID of the receipt user.

10. The device of claim 8, wherein a type of the electronic receipt includes any of a text, an image, or a document file, and the receipt user receives the electronic receipt through any of an SMS, an email, or a mobile terminal of the user.

11. The device of claim 8, wherein the storage device is included in a computer hardware having the electronic receipt management device included therein or the storage device is connected to the electronic receipt management device through an external network connection unit.

12. An electronic receipt data collecting method for execution by a processor of an electronic receipt data collecting device, the method comprising:
collecting data transmitted from a payment device to a printer when a control event transmitted from the payment device to the printer output unit is detected;
converting the collected data into a predefined format; and
transmitting the converted collected data,

13. The method of claim 12, wherein the collecting the data comprises:
dividing the collected data according to a predetermined format;
refining the collected data to generate refined data, the refining comprising removing an unnecessary symbol or text from the divided collected data or inserting a preset value when there is no value corresponding to the predetermined format in the divided collected data; and
converting the refined data into an integrated database format.

14. An electronic receipt management method for execution by a processor of an electronic receipt management device, the method comprising:
receiving receipt data from a receipt data collecting device and inputting the data in an integrated receipt database; and
receiving the receipt data and comparing transaction information in a user database and attribute information of the receipt data for matching a receipt user.

15. The method of claim 14, further comprising:
generating an electronic receipt using the receipt data when the receipt user matches; and
transmitting the electronic receipt to the receipt user using an ID or phone number of the matching receipt user.

16. The method of claim 14, wherein, in the matching of the receipt user, at least from among a credit card number, a phone number, and a receipt ID of the user is used to match the receipt user.

17. The method of claim 15, wherein, in the generating of the electronic receipt, a type of the electronic receipt includes any of a text, an image, or a document file, and the receipt user receives the electronic receipt through the user's email or an SMS.

18. An electronic receipt management system, comprising:
a data collecting device configured to detect a control event transmitted from a payment device to a printer, to collect data transmitted from the payment device to the printer, and to convert the collected data into a predefined format;
an electronic receipt management device configured to receive the converted collected data from the data collecting device as received data, to compare the received data and a user database for matching a receipt user, and to issue an electronic receipt to the matching user; and
a hardware processor configured to implement at least one from among the data collecting device, and the electronic receipt management device.

19. The system of claim 18, wherein the data collecting device divides the collected data according to a predetermined format, removes an unnecessary symbol or text from the divided data, or inserts a preset value when there is no value corresponding to the predetermined format.

20. The system of claim 18, wherein the electronic receipt management device selectively uses any of a credit card number, a phone number, and a receipt ID of the receipt user to match the receipt user, and selectively uses any of an SMS, an email, or a mobile terminal of the receipt user to transmit the electronic receipt.

21. The system of claim 18, further comprising a user terminal configured to send identification information of the receipt user to the electronic receipt management device and to receive the electronic receipt.

22. The system of claim 21, wherein the user terminal provides a dedicated interface for issuing and managing the electronic receipt to the receipt user and provides the identification information to the electronic receipt management device through the interface.

23. The system of claim 21, wherein the identification information selectively uses any of a credit card number, a phone number, and a receipt ID of the receipt user.
